(19) United States
(12) Patent Application Publication
(10) Pub. No.: US 2007/0002879 A1
(43) Pub. Date: Jan. 4, 2007

(54) Gateway control agent and its implementation method

(76) Inventor: Yangbo Lin, Guangdong Province (CN)

Correspondence Address: MCANDREWS HELD & MALLOY, LTD, 500 WEST MADISON STREET, SUITE 3400, CHICAGO, IL, 60661, US

(21) Appl. No.: 11/475,558

(22) Filed: Jun. 27, 2006

(30) Foreign Application Priority Data
Jun. 28, 2005 (CN) 200510035617.8

(51) Int. Cl. H04L 12/56

(52) U.S. Cl. 370/401; 370/352

(57) ABSTRACT

A gateway control agent is disclosed in the present invention, which is set between the media gateway controller and a plurality of media gateways in the packet network. The gateway control agent establishes the mapping relations between the media gateway controller and the media gateways, the media gateway controller uniformly requests for a certain service from the gateway control agent, the gateway control agent then selects the appropriate resource capabilities among the media gateways managed by it and performs mapping between a single media gateway region and the media gateway set region represented by the gateway control agent, and the control operation by the media gateway controller on the resource capabilities in the media gateway set region represented by the gateway control agent is mapped to the resource capabilities of the single media gateway region by the gateway control agent. An implementing method of the gateway control agent is also proposed in the present invention. Therefore, the media gateway controller according to the present invention considers media gateways as a resource set and realizes hierarchical control and simplification operations without the care of the details of a certain MG.

### CROSS-REFERENCE TO RELATED APPLICATIONS/INCORPORATION BY REFERENCE

This patent application makes reference to, claims priority to and claims benefit from Chinese Patent Application No. 200510035617.8 filed on Jun. 28, 2005.

### FIELD OF THE INVENTION

The present invention relates to a gateway control agent (GCA) technology in networks, and more particularly to a GCA based on H.248 protocol and its implementation method.

### BACKGROUND OF THE INVENTION

The media gateway controller (MGC) and the media gateway (MG) are the two key components in the packet network. The MGC is responsible for the call control function and the MG is responsible for the service bearer function, therefore the call control plane and the service bearer plane are separated so as to fully share the network resources, to simplify the equipment update and service expansion, and to greatly reduce the development and maintenance cost. FIG. 1 is the schematic diagram of a kind of MGC and MG networking in the packet network.

The media gateway control protocol (MGCP) is the main protocol applied for the communication between the MG and MGC. Currently H.248/MeGaCo and MGCP are the two comparatively widely used protocols. The MGCP protocol was instituted by Internet Engineering Task Force (IETF) in October 1999 and amended in January 2003. H.248/MeGaCo protocol was instituted by IETF together with International Telecommunications Union (ITU) in November 2000 and amended in June 2003.

Taking H.248 protocol as an example, different resources on the MG are generally referred as a termination, which can be classified into physical terminations and ephemeral terminations. The physical termination represents half-permanent physical entity, such as the time division multiplex (TDM) channel etc. The ephemeral termination represents common resource which is temporarily applied and released after usage, such as the real-time transport protocol (RTP) stream etc. The combination of the terminations is generally referred as a context. The context may comprise a plurality of terminations thus topology is adopted to represent the relations between terminations. Based on the abstract model of the protocol, the connection of a call indeed is the operation on the termination and context.

The aforementioned operation is implemented by the Command Request and Reply between the MGC and MG. The Command types comprise Add, Modify, Subtract, Move, AuditValue, AuditCapabilities, Notify and ServiceChange. The command parameter, also referred as the Descriptor, is sorted as Property, Signal, Event and Statistic. The parameters with service correlation are logically aggregated into a Package.

The original model of H.248 protocol is oriented to MGC-MG control pair, i.e. the MGC knows the resource status on the MG and directly controls the MG. However, with the separation of the control plane and the bearer plane, it seems complicated and trivial for the MGC to directly control the MG, which is not convenient to hierarchically control and to simplify operations.

### BRIEF SUMMARY OF THE INVENTION

The object of present invention is to provide a gateway control agent and its implementation method, which can make the control of the MG by the MGC more simple and effective.

The technical solution of the present invention is to provide a GCA, the gateway control agent is set between the media gateway controller and a plurality of media gateways in the packet network and establishes the mapping relations between the media gateway controller and the media gateways; and the media gateway controller uniformly requests for a certain service from the gateway control agent, the gateway control agent selects the appropriate resource capabilities among the media gateways managed by it and performs mapping between a single media gateway region and the media gateway set region represented by the gateway control agent such that the control operation by the media gateway controller on the resource capabilities in the media gateway set region represented by the gateway control agent is mapped to the resource capabilities of the single media gateway region by the gateway control agent.

Wherein, the mapping relations between the media gateway controller and the media gateways comprise the mapping for varied resource capabilities.

Wherein, the gateway control agent, representing the media gateway set, identifies or operates a certain resource capability in response to the request from the media gateway controller, the media gateway, representing itself, identifies or operates a certain resource capability in response to the request from the gateway control agent, and the gateway control agent establishes mapping relations between the resource capability identified by the gateway control agent and that identified by the media gateway and the mapping relations are accordingly corresponded to the operations.

The one-to-one correspondence of the resource capability on a media gateway and its status is maintained between the gateway control agent and the media gateway, the one-to-one correspondence of the resource capability on the media gateway set and its status is maintained between the media gateway controller and the gateway control agent, and the gateway control agent establishes mapping relations of the resource capabilities between the two planes and the mapping relations are accordingly corresponded to the operations.

Wherein, the gateway control agent further establishes the mapping relations of the operations on resource capabilities between the media gateway controller and the media gateway, and the operations on the resource capabilities comprise the allocation and release, and/or the characteristics amendment and the alteration notification, and/or the status maintenance and synchronization of the resource capabilities.

The present invention also provides an implementation method of GCA, comprising the steps of: the media gateways registering to the gateway control agent set between the media gateway controller and the media gateways in the packet network, while the gateway control agent, representing the media gateway set, registering to the media gateway controller; the gateway control agent selecting the appropriate media gateway according to the service providing request sent from the media gateway controller and sending the command to the media gateway to request for providing the service; the media gateway sending the response command to the gateway control agent; and the gateway control agent operating according to the response command from the media gateway, sending the response command to the media gateway controller, and establishing mapping relations between the media gateway controller and the media gateways.

Wherein, the step of establishing mapping relations between the media gateway controller and the media gateways comprise establishing the mapping for terminations, and/or for contexts.

Wherein, the mapping for contexts comprises: the gateway control agent, representing the media gateway set, allocating and identifying a context in response to the request from the media gateway controller; the media gateway, representing itself, allocating and identifying a context in response to the request from the gateway control agent; and the gateway control agent establishing the mapping relations between the context allocated and identified by the gateway control agent and that allocated and identified by the media gateway and the mapping relations are accordingly corresponded to the operations.

Wherein, the mapping for terminations further comprises the mapping for physical terminations and for ephemeral terminations, wherein the mapping for physical terminations comprises: the one-to-one correspondence of the termination on the media gateway and its status is maintained between the gateway control agent and the media gateway, the one-to-one correspondence of the termination on the media gateway set and its status is maintained between the media gateway controller and the gateway control agent, and the gateway control agent establishes mapping relations of the physical terminations between the two planes and the mapping relations are accordingly corresponded to the operations, and the mapping for ephemeral terminations comprises: the allocation or release of the ephemeral termination between the gateway control agent and the media gateway is performed by the media gateway in response to the request from the gateway control agent, the allocation or release of the ephemeral termination between the media gateway controller and the gateway control agent is performed by the gateway control agent in response to the request from the media gateway controller, and the gateway control agent establishes mapping relations of the ephemeral terminations between the two planes and the mapping relations are accordingly corresponded to the operations.

Wherein, the operations comprise the operations on terminations and contexts, which comprise at least one of the following operations: adding a termination to a context, deleting a termination from a context, moving a termination between the contexts, modifying a termination, initiating notification from a termination, auditing a termination, and the service change of context and termination.

Wherein, the method further comprises that the gateway control agent establishes the mapping relations of the operations on the terminations and the context between the media gateway controller and the media gateway.

The advantages of the present invention are that the media gateway controller introduced by the present invention considers media gateways as a resource set and realizes hierarchical control and simplification operations without the care of the details of a certain MG.

### BRIEF DESCRIPTION OF THE DRAWINGS

FIG. 1 is the schematic diagram of a kind of MGC and MG networking in the packet network;

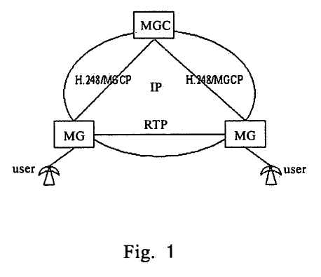

FIG. 2 is a schematic diagram showing the principle of the GCA according to an embodiment of the present invention; and

FIG. 3 is a schematic diagram showing the interactive routine between any two of the MGC, GCA and MG based on H. 248 protocol.

### DETAILED DESCRIPTION OF THE INVENTION

The GCA in the present invention is an entity introduced between the MGC and MG and substitutes the MGC to control the MG. As for the MGC, the GCA represents the set of all the MGs managed by it and its resource capabilities correspond to the sum of those of the all the MGs managed by it. Therefore, the MGC may consider the GCA as MGs and request for service from the GCA. As for MGs, the GCA is the representative of the MGC so all MGs uniformly register to the GCA and the GCA representing MGs registers to the MGC, wherein the registration scheme adopted here is the existing registration scheme H. 248. The GCA will be able to provide services to the MGC as long as one MG registers to the MGC successfully.

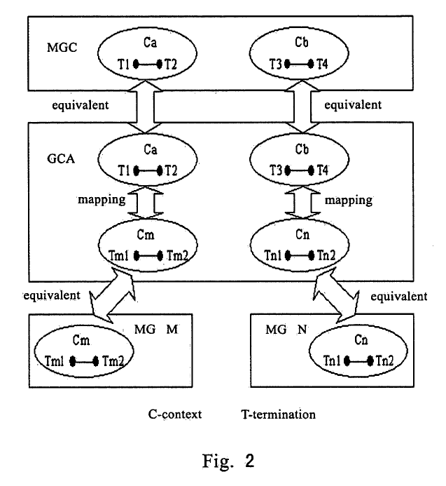

As to the detailed principle of the GCA, please refer to FIG. 2. The understanding of the resource capabilities of the MG set by the GCA is the same as that by the MGC, i.e., the definition, range, form, identification and operation etc. of the resource capabilities of the MG set by the GCA are the same as those by the MGC. The understanding on the resource capabilities of the MG by the GCA is the same as that by the MG, i.e., the definition, range, form, identification and operation etc. of the resource capabilities of the MGs by the GCA are the same as those by the MG. The GCA establishes mapping relations between the two understandings and presents the resource capabilities of all the MGs managed by it to the MGC as an integrity, and thus the MGC doesn't need to care which MG provides a certain resource capability. The MGC requests for the resource capabilities providing certain service from the GCA, and then the GCA selects the resource capabilities satisfying the request from the MGs managed by it and performs mapping between the single MG region and the MG set region represented by the GCA, so that the control operation of the MGC on the resource capabilities of the MG set region represented by the GCA is mapped to the resource capabilities of the single MG region through the GCA.

The GCA establishes the mapping relations of varied resource capabilities between the MGC call model and the MG call model, which comprises the mapping for the termination and the context etc. The context represents the combination relation of terminations relative to a certain call, which is requested from the MGC to the MG and is allocated and identified by the MG. Therefore, the GCA, representing the MG set, allocates and identifies a context in response to the request from the MGC, and the MG, representing itself, allocates and identifies a context in response to the request from the GCA. The GCA establishes mapping relations of the contexts between the two planes and the mapping relations are accordingly corresponded to the operations. The physical terminations represent half-permanent physical entities such as the time division multiplex (TDM) channel. Therefore, the one-to-one correspondence of the termination on the MG and its status is maintained between the GCA and the MG; the one-to-one correspondence of the termination on the MG set and its status is maintained between the MGC and the GCA; and the GCA establishes mapping relations of the terminations between the two planes and the mapping relations are accordingly corresponded to the operations. The ephemeral termination represents common resources which are temporarily applied and released after usage such as the real-time transport protocol (RTP) stream. Therefore, the allocation or release of the ephemeral termination between the GCA and the MG is performed by the MG according to the request from the GCA; the allocation or release of the ephemeral termination between the MGC and the GCA is performed by the GCA according to the request from the MGC; and the GCA establishes mapping relations of the ephemeral terminations between the two planes and the mapping relations are accordingly corresponded to the operations. Accordingly, the GCA establishes the mapping relations of the operations of resource capabilities (such as the termination, context, etc.) between the two planes. The operations of the resource capabilities comprise the allocation and release of the resource capabilities, and/or the characteristics amendment and the alteration notification of the resource capabilities, and/or status maintenance and synchronization of the resource capabilities, specifically, adding a termination to a context, deleting a termination from a context, moving a termination between the contexts, modifying a termination, initiating notification from a termination, auditing a termination, or the service change of context and termination, etc.

The implementation method of the GCA based on H. 248 protocol according to the present invention comprises the following basic steps: firstly, a GCA is set between the MGC and a plurality of MGs in the packet network, wherein the MGs uniformly register to the GCA, and GCA representing the MGs registers to the MGC. When the MGC requests a MG to provide services, the MGC will send a command to the GCA requesting for a certain service; the GCA selects the appropriate MG according to the service providing request sent from the MGC and sends the request to the MG for the service; the MG sends the response command to the GCA; the GCA operates according to the response from the MG, then sends the response command to the MGC, and the GCA establishes mapping relations between the MGC and the MG. An example will be given for the purpose of illustrating the implementing procedure of present invention.

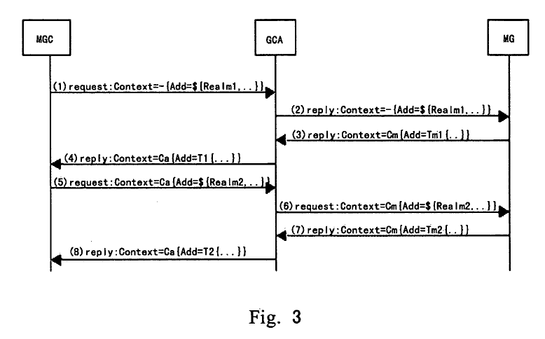

FIG. 3 is the schematic diagram showing the interactive routine between the MGC, GCA and MG based on H. 248 protocol, which explains the process of creating the context including two ephemeral terminations (aiming at different IP domain respectively):

Step 1: the MGC sends Add request command to the GCA, wherein the identifier “-” for the context means to request the GCA to allocate a context, the identifier “$” for the termination means to add an ephemeral termination within the context and the identifier “Realm1” for the IP domain indicates the IP domain for the ephemeral termination.

Step 2: the GCA selects the appropriate MG according to the request from the MGC and sends the Add request command to the MG, wherein the identifier “-” for the context means to request the MG to allocate a context, the identifier “$” for the termination means to add an ephemeral termination within the context and the identifier “Realm1” for the IP domain indicates the IP domain for the ephemeral termination.

Step 3: the MG sends the Add reply command to the GCA, wherein identifier “Cm” for the context indicates the context allocated by the MG, and the identifier “Tm1” for the termination indicates the ephemeral termination added within the context by the MG.

Step 4: the GCA determines whether the Add request sent by the GCA is successful according to the reply from the MG, and if successful sends Add response command to the MGC, wherein the identifier “Ca” for the context indicates the context allocated by the GCA, and the identifier “TI” for the termination indicates the ephemeral termination added within the context by the GCA. At the same time, the GCA establishes the mapping relations between the context Ca and context Cm and between the termination T1 and termination Tm1.

Step 5: the MGC sends the Add request command to the GCA, wherein the identifier “Ca” for the context indicates the object context, the identifier “$” for the termination means to add an ephemeral termination within the context and the identifier “Realm2” for the IP domain indicates the IP domain for the ephemeral termination.

Step 6: the GCA finds the MG where the context Cm, corresponding to the context Ca, exists according to the request from the MGC and sends the Add request command to the MG, wherein the identifier “Cm” for the context indicates the object context, the identifier “$” for the termination means to add an ephemeral termination within the context and the sign “Realm2” for the IP domain indicates the IP domain for the ephemeral termination.

Step 7: the MG sends the Add reply command to the GCA, wherein the identifier “Cm” for the context indicates the object context and the identifier “Tm2” for the termination indicates the ephemeral termination added within the context by the MG.

Step 8: the GCA determines whether the Add request sent by the GCA is successful according to the reply from the MG, and if successful sends the Add response command to the MGC, wherein the identifier “Ca” for the context indicates the object context, and the identifier “T2” for the termination indicates the ephemeral termination added within the context by the GCA. At the same time, the GCA establishes the mapping relations between T2 and Tm2.

The above steps all omit the other information such as the media parameters of the ephemeral termination.

Though illustration and description of the present invention have been given with reference to preferred embodiments thereof, it should be appreciated by ordinary personnel skilled in the art that various changes in forms and details can be made without deviation from the spirit and scope of this invention as defined by the appended claims.

1. A gateway control agent, comprising:
the gateway control agent being set between the media gateway controller and a plurality of media gateways in the packet network, and establishing the mapping relations between the media gateway controller and the media gateways; and
the media gateway controller uniformly requesting for a certain service from the gateway control agent, the gateway control agent selecting the appropriate resource capabilities among the media gateways managed by it and performing mapping between a single media gateway region and the media gateway set region represented by the gateway control agent, such that the control operation by the media gateway controller on the resource capabilities in the media gateway set region represented by the gateway control agent is mapped to the resource capabilities of the single media gateway region by the gateway control agent.

2. The gateway control agent as defined in claim 1, wherein:
the mapping relations between the media gateway controller and the media gateways comprise the mapping for varied resource capabilities.

3. The gateway control agent as defined in claim 2, wherein:
the gateway control agent, representing the media gateway set, identifies or operates a certain resource capability in response to the request from the media gateway controller;
the media gateway, representing itself, identifies or operates a certain resource capability in response to the request from the gateway control agent; and
the gateway control agent establishes mapping relations between the resource capability identified by the gateway control agent and that identified by the media gateway and the mapping relations are accordingly corresponded to the operations.

4. The gateway control agent as defined in claim 2, wherein:
the one-to-one correspondence of the resource capability on a media gateway and its status is maintained between the gateway control agent and the media gateway, the one-to-one correspondence of the resource capability on the media gateway set and its status is maintained between the media gateway controller and the gateway control agent, and
the gateway control agent establishes mapping relations of the resource capabilities between the two planes and the mapping relations are accordingly corresponded to the operations.

5. The gateway control agent as defined in any one from claim 1 to claim 4, wherein:
the gateway control agent further establishes the mapping relations of the operations on resource capabilities between the media gateway controller and the media gateway, and
the operations on the resource capabilities comprise the allocation and release, and/or the characteristics amendment and the alteration notification, and/or the status maintenance and synchronization of the resource capabilities.

6. An implementation method of the gateway control agent, comprises the steps of:
the media gateways registering to the gateway control agent set between the media gateway controller and the media gateways in the packet network, while the gateway control agent, representing the media gateway set, registering to the media gateway controller;
the gateway control agent selecting the appropriate media gateway according to the service providing request sent from the media gateway controller and sending the command to the media gateway to request for providing the service;
the media gateway sending the response command to the gateway control agent; and
the gateway control agent operating according to the response command from the media gateway, sending the response command to the media gateway controller, and establishing mapping relations between the media gateway controller and the media gateways.

7. The implementation method of the gateway control agent as defined in claim 6, wherein:
the step of establishing mapping relations between the media gateway controller and the media gateways comprises establishing the mapping for terminations, and/or for contexts.

8. The implementation method of the gateway control agent as defined in claim 7, wherein the mapping for contexts comprises:
the gateway control agent, representing the media gateway set, allocating and identifying a context in response to the request from the media gateway controller;
the media gateway, representing itself, allocating and identifying a context in response to the request from the gateway control agent; and
the gateway control agent establishing the mapping relations between the context allocated and identified by the gateway control agent and that allocated and identified by the media gateway and the mapping relations are accordingly corresponded to the operations.

9. The implementation method of the gateway control agent as defined in claim 7, wherein the mapping for terminations further comprises the mapping for physical terminations and for ephemeral terminations, wherein:
the mapping for physical terminations comprises:
the one-to-one correspondence of the termination on the media gateway and its status is maintained between the gateway control agent and the media gateway;
the one-to-one correspondence of the termination on the media gateway set and its status is maintained between the media gateway controller and the gateway control agent;
the gateway control agent establishes mapping relations of the physical terminations between the two planes and the mapping relations are accordingly corresponded to the operations; and
the mapping for ephemeral terminations comprises:
the allocation or release of the ephemeral termination between the gateway control agent and the media gateway is performed by the media gateway in response to the request from the gateway control agent;
the allocation or release of the ephemeral termination between the media gateway controller and the gateway control agent is performed by the gateway control agent in response to the request from the media gateway controller; and
the gateway control agent establishes mapping relations of the ephemeral terminations between the two planes and the mapping relations are accordingly corresponded to the operations.

10. The implementation method of the gateway control agent as defined in any one from claim 6 to 9, wherein:
the operations comprise the operations on terminations and contexts, which comprise at least one of the following operations: adding a termination to ae context, deleting a termination from a context, moving a termination between the contexts, modifying a termination, initiating notification from a termination, auditing a termination, and the service change of context and termination.

11. The implementation method of the gateway control agent as defined in claim 10, wherein:
the method further comprises that the gateway control agent establishes the mapping relations of the operations on the terminations and the context between the media gateway controller and the media gateway.
